(19) United States
(12) Patent Application Publication
(10) Pub. No.: US 2004/0073716 A1
(43) Pub. Date: Apr. 15, 2004

(54) System, device and method for media data offload processing

(76) Inventors: Douglas D. Boom, Portland, OR (US); Patrick L. Connor, Portland, OR (US); Mark V. Montecalvo, Hillsboro, OR (US); Scott P. Dubal, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/270,703

(22) Filed: Oct. 14, 2002

(51) Int. Cl. G06F 15/16

(52) U.S. Cl. 709/250

(57) ABSTRACT

Described are a system and method of forwarding data packets from a network interface controller (NIC) to one or more media decoding devices. The NIC may comprise an I/O interface to transmit to communicate with either a host processing system and the one or more media decoding devices. Data packets received at the NIC may be forwarded to the one or more media decoding devices independently of the host processing system.

### BACKGROUND

1. Field

The subject matter disclosed herein relates to computing platforms. In particular, the subject matter disclosed herein relates to computing platforms that transmit data to or receive data from a communication network.

2. Information

Computing platforms typically include peripheral devices such as network interface controllers (NICs) that enable processes hosted on a host processing system to communicate with nodes in a communication network. Computing platforms also typically include devices such as audio or video decoders that can generate sounds or images under the control of device drivers hosted on a host processing system.

Prior art FIG. 1 shows a processing platform 10 comprising a system memory 12 coupled to a central processing unit (CPU) 14 to provide a host processing system. A NIC 20, video output device 22 and audio output device 24 are coupled to the host processing system by a device bus 16. The device bus 16 and front side bus 18 is typically provided in any one of several core logic motherboard chipsets such as core logic chipsets including memory controller hub (MCH) and input/output controller hub (ICH) devices sold by Intel® Corporation.

The NIC 20 typically receives data packets from a communication network which are encapsulated in data frames. The NIC 20 typically transmits received data packets to predefined buffer locations in the system memory 12 to be processed further by the host processing system. To generate sounds or images, device drivers hosted on the host processing system typically transmit data to either the video output device 22 or audio output device from predefined buffer locations in the system memory 12. Upon receipt of data from these drivers, the video output device 22 or audio output device 24 typically decodes the received data into signals for driving media output devices such as displays or audio speakers.

### BRIEF DESCRIPTION OF THE FIGURES

Non-limiting and non-exhaustive embodiments of the present invention will be described with reference to the following figures, wherein like reference numerals refer to like parts throughout the various figures unless otherwise specified.

FIG. 1 shows a schematic diagram of a prior art processing platform.

FIG. 2 shows a system for transmitting media data to a processing platform form a communication network according to an embodiment of the present invention.

FIG. 3 shows a schematic diagram of a processing platform comprising a network interface controller (NIC) to transmit media data to one or more media decoding devices independently of a host processing system according to an embodiment of the system shown in FIG. 2.

FIG. 4 shows a schematic diagram of a processing platform comprising a switch to forward data from a NIC to one or more media decoding devices according to an embodiment of the processing platform shown in FIG. 3.

FIG. 5 shows a flow diagram illustrating a process to initiate the transfer of data from a NIC to one or more media decoding devices in response to a media event according to an embodiment of the processing platform shown in FIG. 3.

FIG. 6 shows a flow diagram illustrating a process of forwarding data packets received at a NIC to one or media devices according to an embodiment of the processing platform shown in FIG. 3.

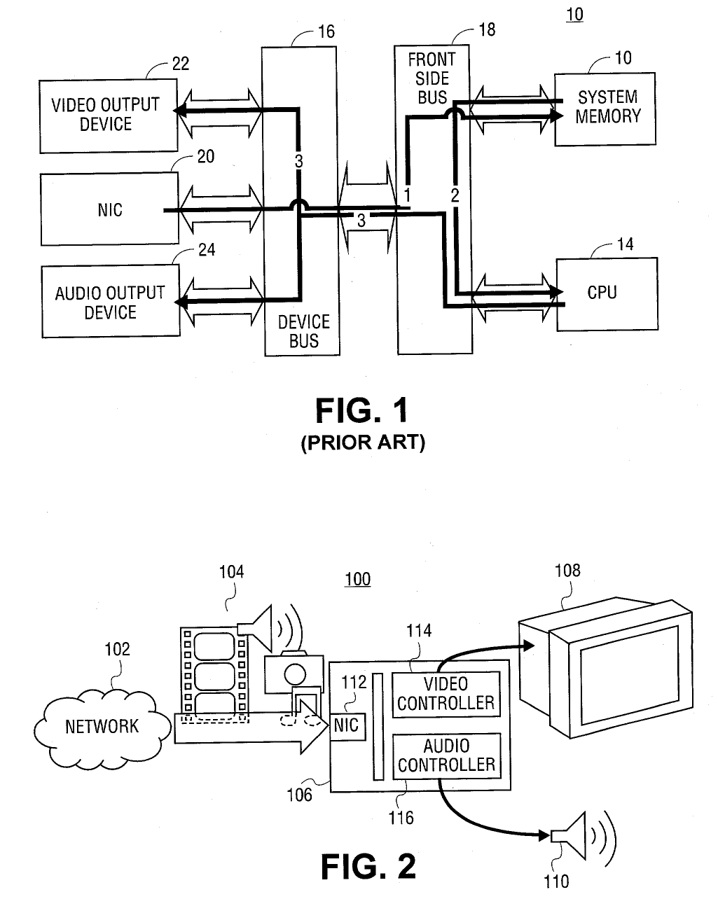

### DETAILED DESCRIPTION

Reference throughout this specification to “one embodiment” or “an emodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

“Machine-readable instructions” as referred to herein relates to expressions which may be understood by one or more machines for performing one or more logical operations. For example, machine-readable instructions may comprise instructions which are interpretable by a processor compiler for executing one or more operations on one or more data objects. However, this is merely an example of machine-readable instructions and embodiments of the present invention are not limited in this respect.

“Storage medium” as referred to herein relates to media capable of maintaining expressions which are perceivable by one or more machines. For example, a storage medium may comprise one or more storage devices for storing machine-readable instructions or data. Such storage devices may comprise storage media such as, for example, optical, magnetic or semiconductor storage media. However, this is merely an example of a storage medium and embodiments of the present invention are not limited in this respect.

“Logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments of the present invention are not limited in these respects.

A “processing system” as discussed herein relates to a combination of hardware and software resources for accomplishing computational tasks. However, this is merely an example of a processing system and embodiments of the present invention are not limited in this respect. A “host processing system” relates to a processing system which may be adapted to communicate with a “peripheral device.” For example, a peripheral device may provide inputs to or receive outputs from an application process hosted on the host processing system. However, these are merely examples of a host processing system and a peripheral device, and embodiments of the present invention are not limited in these respects.

A “data bus” as referred to herein relates to circuitry for transmitting data between devices. For example, a data bus may transmit data between a host processing system and a peripheral device. However, this is merely an example of a data bus and embodiments of the present invention are not limited in this respect. A “bus transaction” as referred to herein relates to an interaction between devices coupled in a bus structure wherein one device transmits data addressed to the other device through the bus structure.

A “network interface controller” (NIC) as referred to herein relates to a device to transmit data to or receive data from a communication network. A NIC may comprise a “network interface” adapted to be coupled to a transmission medium in the communication network. For example, a network interface may comprise one or more of physical communication circuitry to transmit data to or receive data from a particular transmission medium, and a media independent interface to transmit or receive data in a media independent format. However, these are merely examples of a NIC and a network interface, and embodiments of the present invention are not limited in these respects.

A NIC may also comprise an “input/output (I/O) interface” to communicate with other devices. For example, an I/O interface may couple the NIC to devices coupled to a data bus or a switch to transmit data to or receive data according to a protocol. However, this is merely an example of an I/O interface and embodiments of the present invention are not limited in this respect.

A “Data packet” as referred to herein relates to a quantity of data to be transmitted from a source to a destination. A data packet may comprise a “payload” portion comprising a message or portion of a message that is to be received at a destination. A data packet may also comprise a “header” portion comprising information such as a “destination address” to be associated with a packet destination. Such a destination address may be defined according to a network communication protocol. However, these are merely examples of a data packet, payload, header and destination address, and embodiments of the present invention are not limited in these respects.

“Media data” as referred to herein relates to encoded data that represents expressions. For example, media data may comprise encoded data that represents an audio signal or a visual image. Media data may be encoded in any one of several media encoding formats for transmission between a source and a destination. However, these are merely examples of media data and media encoding format, and embodiments of the present invention are not limited in these respects.

A “media decoding device” as referred to herein relates to device to process media data. For example, a media decoding device may process encoded media data to generate an audio signal or a video signal. However, this is merely an example of a media decoding device and embodiments of the present invention are not limited in these respects.

A “Media event” as referred to herein relates to a time period during which one or more media expressions are to be presented. For example, a media event may characterize a period during which sounds or images are generated in response to media data. However, this is merely an example of a media event and embodiments of the present invention are not limited in this respect.

A “forwarding engine” as referred to herein relates to logic to forward data toward a destination based upon destination information. For example, a forwarding engine may forward a received data packet or a portion of a received data packet toward a destination based upon information in a header of the received data packet. However, this is merely an example of a forwarding engine and embodiments of the present invention are not limited in these respects.

“Session information” as referred to herein relates to information that associates data packets with one or more aspects of a media event. For example, session information may be compared to a portion of a data packet to determine whether the data packet is associated with a media event. Also, session information may comprise information that associates a data packet with a component of a media event such as an audio component or a video component. However, these are merely examples of session information and embodiments of the present invention are not limited in these respects.

Briefly, embodiments of the present invention relate to a system and method of forwarding data packets from a NIC to one or more media decoding devices. The NIC may communicate with either a host processing system and the one or more media decoding devices. The NIC may forward media data in received data packets to the one or more media decoding devices independently of the host processing system. However, this is merely an example embodiment of the present invention and other embodiments are not limited in these respects.

FIG. 2 shows a system 100 for transmitting media data 104 to a processing platform 106 from a communication network 102 according to an embodiment of the present invention. The communication network 102 may comprise a source node to transmit data to a NIC 112 according to a network address associated with the NIC 112. For example, an Internet service provider (ISP) (not shown) associated with the network 102 may transmit the media data 104 to the NIC 112 according to any one of several network communication protocols such as, for example, the Transmission Control Protocol/Internet Protocol (TCP/IP) or the User Datagram Protocol (UDP). However, these are merely examples of a network protocol that may be used to transmit media data between nodes in a communication network and other communication protocols may be used. A data packet received at the NIC 112 may comprise destination information (e.g., in a packet header) identifying the NIC 112, a video controller 114 or audio controller 116 as a destination to receive the data packet. The data packet may also comprise information to associate the data packet a part of a stream of data packets in a session (e.g., session identifier or port numbers in a TCP/IP packet header).

The NIC 112 may be adapted to be coupled to the communication network 102 using any one of several types of data transmission media including, for example, twisted wire pair cabling, coaxial cabling or fiber optic cabling. Alternatively, the NIC 112 may be coupled to the communication network 102 by a wireless data link. However, these are merely examples of data transmission media that may be used to transmit data from a communication network to a NIC and embodiments of the present invention are not limited in these respects. The NIC 112 may also be adapted to receive data according to data link protocol such as versions of the Ethernet protocol according to IEEE Std. 802.3 or versions of the wireless local area network (WLAN) protocols according to IEEE Std. 802.11. However, these are merely examples of data link protocols that may be used to transmit data to a NIC from a communication network and embodiments of the present invention are not limited in these respects.

According to an embodiment, the media data 104 may comprise encoded audio data or video data that may be used for generating sounds or images. However, these are merely examples of types of media data and embodiments of the present invention are not limited in these respects. The media data 104 may be encoded using any one of several media encoding or compression techniques including standard based encoding techniques such as MPEG, JPEG, AVI, MP3, WMA, RealAudio, RealVideo, Divx, Ogg Vorbis and H.263. However, these are merely examples of techniques to encode and/or compress media data and other techniques (including proprietary encoding and compression techniques) may be used.

Upon receipt of data packets containing the media data 104, the NIC 112 may forward the received media data to either the video controller 114 or the audio controller 116 based upon information in the data packet. Upon receipt of audio data from the NIC 116, the audio controller 116 may decode and/or decompress the audio data according to a compression format to provide a signal to a speaker 110 to generate sound. Similarly, upon receipt of video data from the NIC 116, the video controller may decode and/or decompress the video data to provide a signal to a display 108 to generate images.

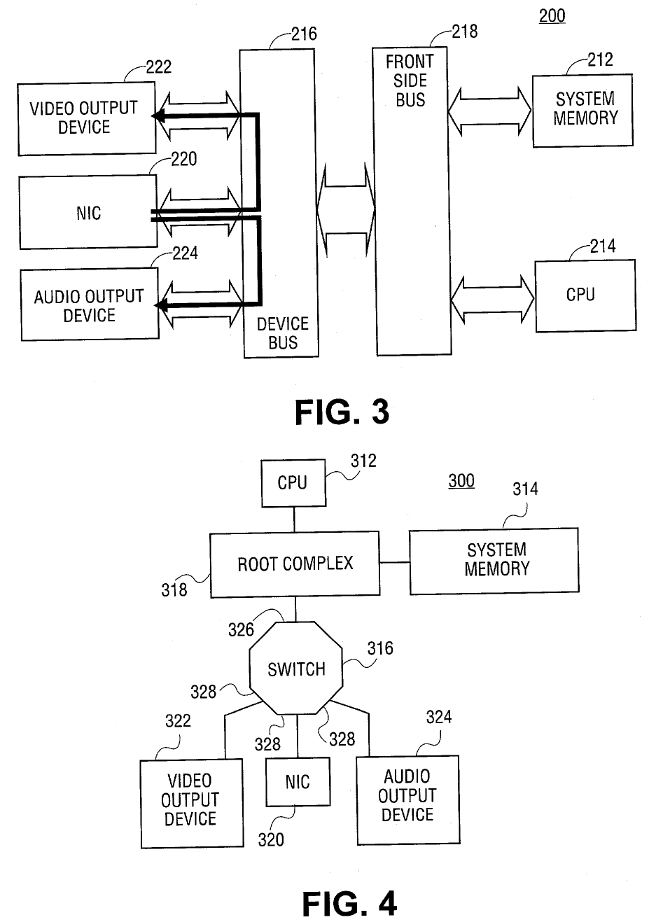

FIG. 3 shows a schematic diagram of a processing platform 200 comprising a NIC 220 to transmit data to one or more media decoding devices independently of a host processing system according to an embodiment of the system shown in FIG. 2. A central processing unit (CPU) 214 and system memory 212 may be coupled by a front side bus 218 to form a host processing system for hosting an operating system, application programs and device drivers to communicate with peripheral devices. A device bus 216 may couple the NIC 220 and media decoding devices such as an audio output device 224 and video output device 222 to the host processing system. The device bus 216 and front side bus 218 may be formed in core logic of a motherboard chipset. In one embodiment, the video output device 222 may be coupled to the device bus 216 by an Advanced Graphics Port (AGP) (not shown) which is coupled to or formed in a memory controller hub of the motherboard chipset. However, this is merely an example of how a video output device may be coupled to a device bus and embodiments of the present invention are not limited in these respects.

The CPU 212 may comprise any one of several commercially available CPUs such as, for example, versions of the Celeron®, Pentium®, Xeon® or Itanium® processors sold by Intel Corporation. However, these are merely examples of a CPU that may be used in a host processing system and embodiments of the present invention are not limited in these respects. The system memory 212 may comprise any one of several types of storage media including, for example dynamic random access memory (DRAM), synchronous DRAM, or dual-rate DRAM. However, these are merely examples of storage media that may be used to form a system memory and embodiments of the present invention are not limited in these respects. The operating system hosted on the host processing system may comprise operating system modules from any one of several commercially available operating systems such as versions of Windows® sold by Microsoft Corp. or Solaris® sold by Sun Microsystems, Inc., or versions of Linux available in the open source community. However, these are merely examples of operating systems that may be hosted on a host processing system and embodiments of the present invention are not limited in these respects.

According to an embodiment, the NIC 220 may transmit data to either the video output device 222 or the audio output device 224 independently of the host processing system. Upon receipt of a data packet from a communication network, the NIC 220 may forward media data in received data packets to a destination media decoding device through the device bus 216 without storing the data packet or media data in the system memory 212.

According to an embodiment, the NIC 220 may comprise logic to receive data packets in data frames received from a communication network according to a data link protocol. For example, the NIC 220 may comprise a physical layer device and a media access controller (MAC) to receive data frames from a data transmission medium. The NIC 220 may also comprise an off-load engine to process the received data packets according to a network protocol to determine a destination for the received data packets. In an embodiment in which the data packets are formatted according to the TCP/IP protocol, for example, the NIC 220 may comprise a TCP/IP offload engine (TOE) (not shown) to perform TCP/IP processing. The TOE may comprise a microcontroller or ASIC formed in or coupled to the NIC 220. However, these are merely examples of how a TOE may be provided in a NIC and embodiments of the present invention are not limited in these respects.

According to an embodiment, a received data packet identified as a TCP/IP packet may comprise header information that may be provided to the TOE for TCP/IP processing to determine, for example, a destination for the data packet. The TOE may also associate the received data packet with a particular data stream in a session based upon, for example, a session identifier and/or information in the TCP/IP header such as source or destination port number, or packet sequence number. The data packet may then be associated with a particular media event or particular media decoding devices to receive the media data in the data packet. In addition to associating the destination with a media session, the NIC 220 may detect a particular media data type (e.g., video data or audio data) and/or media encoding format associated with media data in a payload portion of the data packet to determine a particular destination media decoding device corresponding to the detected media data type and/or media encoding format.

According to an embodiment, all or portions of the media data in a received data packet may be encrypted according to any one of several encryption formats such as, for example, IP Security (IPSec) or Secure Sockets Layer (SSL) encryption formats. However, these are merely examples of encryption formats that may be used to encrypt packetized media data and embodiments of the present invention are not limited in these respects. In addition to performing packet level processing (e.g., TCP/IP processing), the NIC 220 may comprise logic to decrypt media data prior to forwarding the media data to a destination media decoding device. Alternatively, the media decoding devices may comprise decryption logic to decrypt media data that is forwarded by the NIC 220. However, these are merely examples of how media data may be decrypted and embodiments of the present invention are not limited in these respects.

In another alternative embodiment to the processing platform 200 shown in FIG. 3, the NIC 220 may comprise logic to decode media data in received data packets and provide decoded media signals (e.g., decoded video signals in an NTSC format) to drive an output device. In other alternatives, the NIC 220 may at least partially decode media data in received data packets and forward partially decoded media data to media decoding devices for additional decoding into media signals for driving an output device. However, these are merely examples of how a NIC may perform decoding of media data prior to forwarding to a destination and embodiments of the present invention are not limited in these respects.

According to an embodiment, the NIC 220 may forward media data from received data packets using data bus transactions including direct memory access (DMA) write transactions where the NIC 220 is acting as a bus master. The video output device 222 and audio output device 224 may each comprise memory (e.g., buffer memory) which is addressable through bus transactions on the device bus 216 addressed to the recipient media decoding device. Using techniques known to those of ordinary skill in the art, the video output device 222 and audio output device 224 may each be configured (e.g., during a bus enumeration procedure) to claim bus transactions addressed to one or more predetermined addresses. For example, an enumeration procedure controlled by the host processing system may set base address registers (BARs) associated with a media decoding device on a data bus to determine which bus transactions the media decoding device is to claim. Accordingly, the NIC 220 may forward media data from received data packets to a media decoding device (e.g., the video output device 222 or audio output device 224) independently of the host processing system by initiating DMA write transactions addressed to the media decoding device.

FIG. 4 shows a schematic diagram of a processing platform 300 comprising a switch 316 to forward data from a NIC 320 to one or more media decoding devices according to an embodiment of the processing platform 200 shown in FIG. 3. A CPU 312 may be coupled to a system memory 314 by a root complex 318 to provide a host processing system. The root complex 318 and switch 316 may be included in a core logic motherboard chipset formed according to a Peripheral Components Interconnect (PCI) Express I/O architecture as described in the PCI Express Base Specification, Rev. 1.0, Jul. 16, 2002 (hereinafter “PCI Express Base Specification”). The switch 316 may comprise a plurality of ports including an upstream port 326 coupled to the root complex 318 and downstream ports 328 coupled to the NIC 320, a video output device 322 and an audio output device 324. The NIC 320, video output device 322 and audio output device 324 may be configured as “endpoint” devices as provided in the PCI Express Base Specification, Chapter 1.

According to an embodiment, the NIC 320 may forward media data in received data packets to either the video output device 322 or audio output device 325 through the switch 316 and independently of processes hosted on the host processing system. Upon receipt of a data packet from a communication system, the NIC 320 may process the received data packet according to a network protocol (e.g., TCP/IP) to determine a destination. Based upon the destination, the NIC 320 may then forward media data from the data packet through the switch 316 to a media decoding device coupled to a downstream port 328 by, for example, initiating a DMA write transaction addressed to the media decoding device.

It should be understood that the NIC 320 may employ endpoint to endpoint routing protocols to forward media data to either the video output device 322 or audio output device 324 according to the PCI Express Base Specification. While FIG. 4 shows the NIC 320, video output device 322 and audio output device 324 coupled to downstream ports 328 of a common switch 316, it should be understood that more than one switch may be used to couple these devices through a root node. Additionally, one or more of the NIC 320, video output device 322 and audio output device 324 may be coupled directly to a root complex while the other devices are coupled to downstream ports of a switch. However, these are merely examples of how a NIC may forward media data to endpoint devices independently of a host processing system and embodiments of the present invention are not limited in these respects.

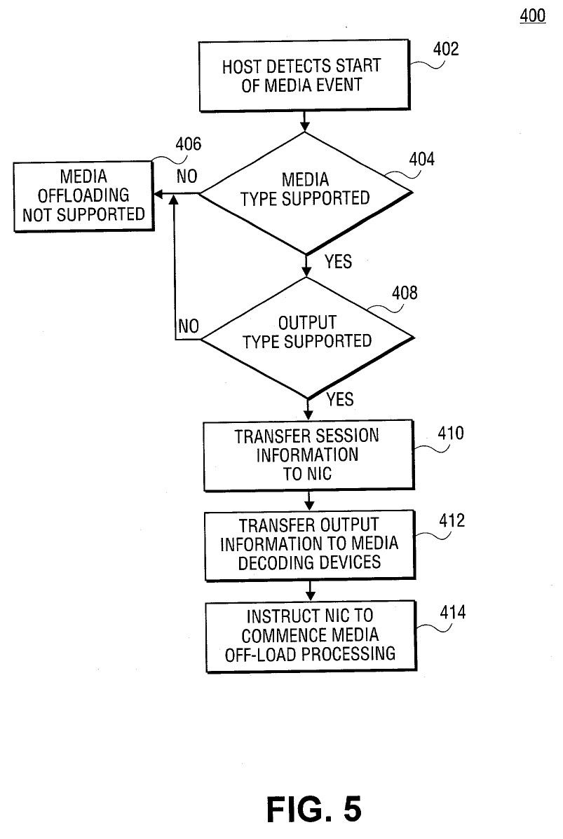

FIG. 5 shows a flow diagram illustrating a process 400 initiate the transfer of data from a NIC to one or more media decoding devices in response to a media event according to an embodiment of the processing platform 200 shown in FIG. 3. The process 400 may be executed by a host processing system under the control of machine-readable instructions stored in a storage medium (e.g., the system memory 212). At block 402, a process on the host processing system may detect the start of a media event. The start of the media event may be detected by an application program by, for example, detecting a “play” command or the enqueuing of a media title (e.g., the enqueuing of a song or video clip). Alternatively, a media event may be detected by detecting a receipt of one or more data packets a media server as part of an acknowledgement to a request transmitted by the host processing system according to a “handshaking” protocol. However, these are merely examples of how the start of a media event may be detected and embodiments of the present invention are not limited in these respects.

The media event (detected at block 402) may be characterized as a “session” during which data packets may be received from a media server and processed (e.g., for driving media output devices). The media data in the data packets received in a media event may be formatted according to any one of several media encoding formats or media types (e.g., MPEG, AVI, MP3, JPEG, WMA, H.263, RealAudio or RealVideo). The media type may be detected upon detection of the media event at block 402. Diamond 404 determines whether the media offloading system is capable of processing the media data in the data packets based upon the associated media type.

Diamond 408 may determine the availability of media decoding devices to process the media data (to be received in data packets during the media event) based upon the media type associated with the media data. For example, diamond 408 may determine the availability of media decoding devices coupled to a data bus which are capable of decoding media data from a particular media encoding format. Diamond 408 may also determine whether any of these media decoding devices are capable of claiming DMA write transactions on a data bus (e.g., whether any media decoding device comprises sufficient addressable memory which is accessible by the data bus). According to an embodiment, diamond 408 may determine the availability of such media decoding devices from configuration tables formed by the host processing system during data bus enumeration and/or attempting to forward media data to one or more media decoding devices. However, these are merely examples of determining the availability of a media decoding device to decode media data encoded in a particular format, and embodiments of the present invention are not limited in these respects.

If media off-loading is supported as determined at diamonds 404 and 408, block 410 may transmit session information to the NIC 220 and block 412 may transmit output information to one or more media decoding devices. Such session information may enable the NIC 220 to associate a received data packet with a media event and forward media data to a media decoding device. Such session information for use in associating an incoming data packet with the media event may include information to be compared with information in the data packet such as information of TCP/IP header (e.g., source or destination port number or packet sequence number). Alternatively, such session information may be compared with a session identifier encapsulated in a payload portion of the data packet. However, these are merely examples of information in a received data packet that may be associated with a media event and embodiments of the present invention are not limited in these respects.

Session information transmitted to the NIC 220 at block 410 may also include, for example, address information associated with each media decoding device (e.g., addresses to which DMA bus transactions may be addressed), a decryption format or key, and information to be used in associating incoming data packets with the media event. However, these are merely examples of session information that may be provided to a NIC to execute off-loaded processing and embodiments of the present invention are not limited in these respects.

The session information may enable the NIC 220 to associate the media data in each data packet with a destination media decoding device capable of processing the media data. For example, the NIC 220 may construct a look lip table in memory (not shown) to associate information in received data packets (e.g., session identifier and/or information in a TCP/IP header such as source or destination port numbers or packet sequence numbers) with address information associated with each destination media decoding device. The NIC 220 may subsequently forward media data from a received data packet toward a destination media decoding device based upon the address information associated with information in the data packet.

Output information transmitted to the media decoding devices at block 412 may include, for example, information identifying data encoding, compression or encryption formats, or encryption keys to be used in processing media data received from the NIC 220. Output information may also include any data formats in which a media decoding device is to receive the forwarded media data from the NIC. However, these are merely examples of output information that may be provided to a media decoding device to process media data and embodiments of the present invention are not limited in these respects. Block 414 notifies the NIC 220 to commence forwarding media data to the media decoding devices.

While block 412 shows that output information is provided to the media decoding devices from the host processing system according to the embodiment of process 400, in alternative embodiments the NIC 220 may provide output information to the media decoding device transparently to the host processing system following block 414. In one embodiment, the host processing system may provide the output information to the NIC 220 and the NIC 220 subsequently forwards the output information to the media decoding devices. Alternatively, the NIC 220 may provide the output information to the media decoding devices from a memory device (not shown) independently of the host processing system.

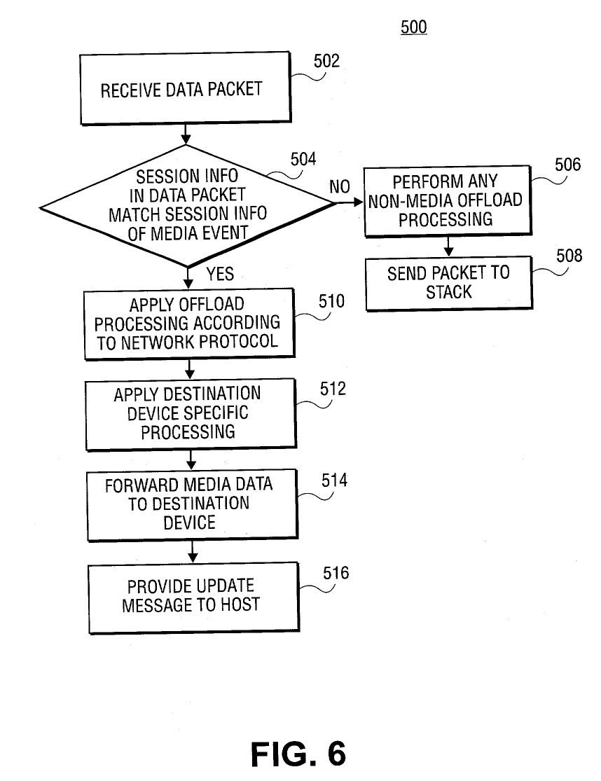

FIG. 6 shows a flow diagram illustrating a process 500 of forwarding data packets received at the NIC 220 to one or media decoding devices according to an embodiment of the processing platform shown in FIG. 3. In one embodiment, the process 500 may be executed following, or in response to, the process 400 illustrated in FIG. 5. The process 500 may also be executed by logic in the NIC 220 such as an embedded microcontroller to execute machine-readable instructions stored in an embedded storage device. Alternatively, the process 500 may be controlled by logic in an ASIC or FPGA embedded in or coupled to the NIC 220. However, these are merely examples of logic that may be implemented in conjunction with a NIC to process and forward media data to devices independently of a host processing system, and embodiments of the present invention are not limited in these respects.

At block 502, the NIC 220 may receive a data packet from a communication network originating at, for example, a media server coupled to the communication network. Diamond 504 may determine whether information in the received data packet (e.g., session identifier and/or information in a TCP/IP header such as packet sequence number or source or destination port numbers) matches session information associated with a media event (e.g., session information provided to the NIC 220 at block 410). For example, diamond 504 may associate information in the received data packet by accessing a TCP/IP offload cache table to obtain session information associated with the media event. If information in the received data packet is associated with the media event, then block 512 may perform off-load processing including, for example, processing packet header information according to a network communication protocol to associate an address of a destination media decoding device (e.g., TCP/IP header processing according to look up table) and any decrypting of payload contents. However, these are merely examples of off-load processing and embodiments of the present invention are not limited in these respects.

At block 512, the NIC 220 may additionally process media data from a received data packet to be in a format which can be processed by the media decoding device that is to receive the data packet. For example, for data packets to be forwarded to one particular media decoding device, block 512 may strip header information from the data packet and combine payload media data with the media data from other data packets in a reassembled data structure to be forwarded. Additionally, the NIC 220 may decode all or a portion of media data in a data packet payload and forward decoded media data to a destination media decoding device. The media decoding device may then perform some additional decoding or no additional decoding on the decoded media data to generate a signal to drive a media output device. For another particular media decoding device capable of receiving media data in network protocol data packets (e.g., TCP/IP data packets), block 512 may merely enable forwarding the received data packet intact. However, these are merely examples of how a NIC may process a data packet based upon a particular destination device and embodiments of the present invention are not limited in these respects.

At block 514, the NIC 220 may forward media data from received data packets (processed at blocks 510 and 512) to a destination media decoding device (e.g., the video output device 222 or audio output device 224) independently of the host processing system based upon the destination information determined at block 510. For example, the NIC 220 may initiate a DMA write transaction addressed to the destination media decoding device (e.g., DMA write transaction addressed to an address that is claimed by the destination media decoding device). Block 516 may then provide an status update message to a process at the host processing system.

While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

What is claimed is:

1. A system comprising:
a host processing system;
one or more media decoding devices; and
a network interface controller, the network interface controller comprising:
a network interface to receive data packets from a data transmission medium;
an I/O interface to communicate with the host processing system and the one or more media decoding devices; and
a forwarding engine to forward media data in received data packets to the one or more media decoding devices independently of the host processing system.

2. The system of claim 1, wherein the system further comprises a switch comprising a plurality of ports, at least one port being coupled to the I/O interface and at least one port being coupled to the one or more media decoding devices.

3. The system of claim 1, wherein the network interface controller further comprises a physical layer device coupled to the network interface to receive the data packets from a twisted wire pair transmission medium.

4. The system of claim 1, wherein the network interface controller further comprises a physical layer device coupled to the network interface to receive the data packets from an optical transmission medium.

5. The system of claim 1, wherein the network interface controller further comprises a physical layer device coupled to the network interface to receive the data packets from a wireless transmission medium.

6. A network interface controller comprising:
a network interface to receive data packets from a data transmission medium;
a forwarding engine to:
receive from a host processing system session information associated with a media event; and
forward media data in data packets associated with the session information to a destination media decoding device independently of the host processing system.

7. The network interface controller of claim 6, wherein the data forwarding engine further comprises logic to associate a received data packet with the destination media decoding device from among a plurality of media decoding devices based upon the session information.

8. The network interface controller of claim 7, wherein the network interface controller further comprises logic to initiate a direct memory access transaction to forward media data to the destination media decoding device.

9. The network interface controller of claim 6, wherein the network interface controller comprises logic to decrypt at least a portion of media data in data packets associated with the session information.

10. The network interface controller of claim 6, wherein the data forwarding engine further comprises:
logic to associate a plurality of data packets with a destination media decoding device based upon the session information;
logic to combine media data portions of the plurality of data packets into a data structure; and
logic to forward the data structure to the destination media decoding device independently of the host processing system.

11. The network interface controller of claim 6, wherein the forwarding engine further comprises logic to associate the received data packets with the media event based upon a comparison of at least a portion of the session information with a portion of information in the received data packets.

12. The network interface controller of claim 11, wherein the portion of information in the received data packets comprises a session identifier.

13. The network interface controller of claim 11, wherein the portion of information in the received data packets comprises a TCP/IP header.

14. A method comprising:
detecting a media event; and
transmitting session information associated with the media event to a network interface controller, the session information associating at least some data packets received at the network interface controller with one or more destination media decoding devices.

15. The method of claim 14, the method further comprising:
associating the media event with one or more media encoding formats; and
detecting the presence of one or more media decoding devices capable of processing media data encoded in the one or more media encoding formats.

16. The method of claim 14, wherein the session information comprises information to associate media data in received data packets with an address of a destination media decoding device.

17. The method of claim 14, the method further comprising transmitting output information to at least one of the destination media decoding device, the output information identifying a media encoding format associated with media data in data packets to be forwarded to the destination media decoding device.

18. An article comprising:
a storage medium comprising machine-readable instructions stored thereon to:
detect a media event; and
initiate transmission of session information associated with the media event to a network interface controller, the session information associating at least some data packets received at the network interface controller with one or more destination media decoding devices.

19. The article of claim 18, wherein the storage medium further comprises machine-readable instructions stored thereon to:
associate the media event with one or more media encoding formats; and
detect the presence of one or more media decoding devices capable of processing media data encoded in the one or more media encoding formats.

20. The article of claim 18, wherein the session information comprises information to associate media data in received data packets with an address of a destination media decoding device.

21. The article of claim 18, wherein the storage medium further comprises machine-readable instructions stored thereon to initiate transmission of output information to at least one of the destination media decoding device, the output information identifying a media encoding format associated with media data in data packets to be forwarded to the destination media decoding device.

22. A method comprising:
receiving session information from a host processing system;
receiving data packets from a transmission medium;
associating at least some of the received data packets with the session information; and
forwarding portions of the associated data packets to one or more destination media decoding devices independently of the host processing system.

23. The method of claim 22, the method further comprising decrypting the portions of the associated data packets prior to forwarding to the one or more destination media decoding devices.

24. The method of claim 22, the method further comprising associating the at least some of the received data packets with the session information based, at least in part, TCP/IP information in the received data packets.

25. The method of claim 22, wherein the data forwarding engine further comprises logic to associate a received data packet with the destination media decoding device from among a plurality of media decoding devices based upon the session information.

26. The method of claim 22, wherein forwarding a portion of a received data packet associated with a destination media decoding device further comprises initiating a direct memory access transaction to forward media data in the received data packet to the destination media decoding device.

27. The method of claim 22, the method further comprising:
associating a plurality of received data packets with a destination media decoding device based upon the session information;
combining media data portions of the plurality of data packets into a data structure; and
forwarding the data structure to the destination media decoding device independently of the host processing system.

28. An article comprising:
a storage medium comprising machine-readable instructions stored thereon to:
receive session information from a host processing system;
associate at least some received data packets with the session information; and
initiate forwarding portions of the associated data packets to one or more destination media decoding devices independently of the host processing system.

29. The article of claim 28, wherein the storage medium further comprises machine-readable instructions stored thereon to decrypt the portions of the associated data packets.

30. The article of claim 28, wherein the storage medium further comprises machine-readable instructions stored thereon to associate the at least some of the received data packets with the session information based on, at least in part, TCP/IP information in the received data packets.

31. The article of claim 28, wherein the storage medium further comprises machine-readable instructions stored thereon to associate a received data packet with a destination media decoding device from among a plurality of media decoding devices based upon the session information.

32. The article of claim 31, wherein storage medium further comprises machine-readable instructions stored thereon to initiate a direct memory access transaction to forward media data in the received data packet to the destination media decoding device.

33. The article of claim 28, wherein the storage medium further comprises machine-readable instructions stored thereon to:
associate a plurality of received data packets with a destination media decoding device based upon the session information;
combine media data portions of the plurality of data packets into a data structure; and
forward the data structure to the destination media decoding device independently of the host processing system.
